(19) United States
(12) Patent Application Publication
(10) Pub. No.: US 2024/0425416 A1
(43) Pub. Date: Dec. 26, 2024

(54) PREPARATION METHOD FOR LOW-LINE-WIDTH W-TYPE HEXAGONAL CRYSTAL SYSTEM MICROWAVE FERRITE MATERIAL

(71) Applicant: HENGDIAN GROUP DMEGC MAGNETICS CO., LTD, Dongyang City Jinhua, Zhejiang (CN)

(72) Inventors: Feiyu LV, Dongyang City Jinhua, Zhejiang (CN); Likang ZHANG, Dongyang City Jinhua, Zhejiang (CN)

(21) Appl. No.: 18/705,830

(22) PCT Filed: May 25, 2023
(86) PCT No.: PCT/CN2023/096164

§ 371 Date: Apr. 29, 2024

(30) Foreign Application Priority Data
Jun. 29, 2022 (CN) 202210756747.4

(51) Int. Cl. C04B 35/26; C04B 35/626; C04B 35/63; C04B 35/64

(52) U.S. Cl. CPC C04B 35/2633; C04B 35/6262; C04B 35/6263; C04B 35/62655; C04B 35/62675; C04B 35/62695; C04B 35/6303; C04B 35/64; C04B 2235/3224; C04B 2235/3274; C04B 2235/3279; C04B 2235/3284; C04B 2235/3298; C04B 2235/3409; C04B 2235/3418; C04B 2235/442; C04B 2235/5436; C04B 2235/5445; C04B 2235/606; C04B 2235/608; C04B 2235/6562; C04B 2235/6565; C04B 2235/6567; C04B 2235/6583

(57) ABSTRACT

The present application discloses a preparation method for a low-line-width W-type hexagonal crystal system microwave ferrite material. The preparation method comprises: performing weighing, first ball milling treatment, drying, first sintering treatment, second ball milling treatment, granulation and molding, and second sintering treatment in sequence to obtain a low-line-width W-type hexagonal crystal system microwave ferrite material. According to the preparation method of the present application, a rare earth element Gd is employed to replace some Fe ions, appropriate saturation magnetization, remanence ratio and line width are obtained by using electromagnetic properties of Gd and Fe and compensation points, and the microstructure of the W-type hexagonal crystal system microwave ferrite material is improved by jointly adding appropriate quantities of low-melting-point fluxing agents Bi₂O₃, V₂O₅, SiO₂ and ZnO, so that pores are reduced, the line width is decreased and the remanence ratio is increased. The preparation method has good process stability and good repeatability, and is suitable for mass production.

### TECHNICAL FIELD

Examples of the present application relate to the technical field of magnetic materials, for example, a preparation method for a low line-width W-type hexagonal microwave ferrite material.

### BACKGROUND

With the rapid development of electronic information technology, the importance of radars applied in the military fields and civilian fields is increasing. For the active phased array radar, a large number of radiating units are arranged in an array, and some or even all of the radiating units on the antenna array are equipped with a transmit/receive module individually.

The transmit/receive module is the core component of the antenna array of the active phased array radar, and is required to complete the transmission and reception of radio-frequency signals under the constraint of extremely small volume. The component has been highly integrated through the monolithic microwave integrated circuit technology but has not been sufficiently miniaturized and chipped due to the limitation of the size of the circulator. The circulator is an indispensable component which connects to three modules (a transmitter, an antenna, and a receiver) in the transmit/receive module due to its nonreciprocity, but the conventional circulator designed based on the garnet-type ferrite and spinel-type ferrite requires the external permanent magnet with a large size to provide a bias field to achieve the circulation function, and as the operating frequency of the circulator increases, the required volume of the permanent magnet is increased. Therefore, reducing the size of the circulator is an unavoidable key issue to realize further miniaturization and integration of transmit/receive modules.

CN106747391A discloses a preparation method for a circulator substrate based on a casting process, comprising the following steps: 1. a main material formulation: employing Y₃₋ₓCaₓSnₓFe₅₋ₓO₁₂, x=0.06; 2. first ball-milling; 3. pre-sintering: performing pre-sintering at 1000-1200° C., and holding the temperature for 1-3 h; 4. doping: adding the following additives: 0.2 wt % of Bi₂O₃ and 0.10 wt % of BaTiO₃; 5. second ball-milling: adding 40-50 wt % of an organic binder and 40-50 wt % of absolute ethanol into the powder, and performing ball-milling for 4-8 h; 6. tape casting: casting the slurry to obtain a film strip with a thickness of 100-120 μm; 7. lamination: according to a thickness need, stacking the film strip by 8-15 layers, and performing compression molding at 6 MPa; and 8. sintering: holding at 1360-1440° C. for 4 h in an air atmosphere. The smooth and flat ferrite dielectric substrate for circulators with different thickness can be prepared by this method, which has characteristics suitable for the X-band, and the advantages of good temperature stability, low line-width, and low dielectric loss.

CN102584200A discloses an ultra-low-loss, small line-width microwave ferrite material and a preparation method therefor. A main phase of the material is a garnet structure, and has a chemical formula of: Y_{3-2x-y}Ca_{2x+y}Fe_{5-x-y-z}VₓZr_{y}Al_{z}O₁₂, wherein: 0.02≤x≤0.25, 0.05≤y≤0.25, and 0.01≤z≤0.25; the preparation method comprises the following steps: weighing raw materials according to stoichiometric calculations, vibratory ball-milling, pre-sintering, vibratory coarse-grinding, sand-milling fine-grinding, spray granulation, compression molding, and sintering. After the test, the obtained material has a ferromagnetic resonance line-width ΔH of less than or equal to 1.27 KA/m, and a dielectric loss tgδe of less than or equal to 0.5×10⁻⁴, an insertion loss of the assembled microwave device is less than or equal to 0.21 dB, its stability and reliability are greatly improved, and the application range is expanded; the prepared microwave ferrite devices have the advantages of wide operating frequency band and low insertion loss.

CN111732427A discloses a low-ferromagnetic resonance line width hexagonal ferrite material for self-biased circulators which is composed of a main component and a doping component, wherein the main component comprises: (6.5-7) mol of Fe₂O₃, (1-1.17) mol of BaCO₃, and (0-1) mol of Ga₂O₃, and the doping components comprises: (0.01-1)wt % of CuO, (0.01-3)wt % of Bi₂O₃, and (0.01-1.5)wt % of B₂O₃; CN111732427A also discloses a preparation method for the above material; the prepared material has a high anisotropy field, high saturation magnetization, low ferromagnetic resonance line-width and suitable coercivity, and the preparation method is simple and easy to operate; because the material has a high anisotropy field, it can replace the external permanent magnet of the circulator, reducing the size of the circulator, and increasing the working frequency of the device; the low ferromagnetic resonance line width can effectively reduce the loss of the self-biased circulator.

The current hexagonal ferrite materials have been unable to meet the new requirements of engineering due to a high ferromagnetic resonance line width and a high loss.

Therefore, it is of great significance to develop a preparation method for a low line-width W-type hexagonal microwave ferrite material.

### SUMMARY

The following is a summary of the subject described in detail herein. This summary is not intended to limit the protection scope of the claims.

In order to solve the above technical problems, an example of the present application provides a preparation method for a low line-width W-type hexagonal microwave ferrite material. By replacing partial Fe ions with rare-earth element Gd, the electromagnetic characteristics and compensation points of Gd and Fe are utilized to obtain an appropriate saturation magnetization, remanence ratio, and line-width, and by the combined addition of appropriate amounts of low-melting-point fluxing agent Bi₂O₃, V₂O₅, SiO₂, and ZnO, the microstructure of the W-type hexagonal microwave ferrite material can be improved, pores can be reduced, the line-width can be reduced and the remanence ratio can be increased. The preparation method in the present application has a stable process and good repeatability, and is suitable for mass production.

An example of the present application provides a preparation method for a low line-width W-type hexagonal microwave ferrite material, and the preparation method comprises:
(1) weighing BaCO₃, Gd₂O₃, Ni₂O, and Fe₂O₃ as raw materials according to calculation based on a chemical formula of BaGdₓNi₂Fe₍₁₆₋ₓ)O₂₇, in which 0.1<x<0.25, and then performing a first ball-milling treatment to obtain a first ball-milled slurry with a particle size X50 of 0.9-1.2 μm;
(2) sequentially subjecting the first ball-milled slurry to drying and a first sintering treatment which is performed at a temperature of 1200-1280° C. to obtain a mixed powder; (3) mixing the mixed powder and a fluxing agent, performing a second ball-milling treatment to obtain a second ball-milled slurry with a particle size X50 of 0.8-1.1 μm; components and mass contents of the fluxing agent are: 0.01-0.1% of Bi₂O₃, 0.01-0.1% of V₂O₅, 0.01-0.1% of SiO₂, and 0.01-0.1% of ZnO; and
(4) sequentially subjecting the second ball-milled slurry to granulation-molding and a second sintering treatment to obtain the low line-width W-type hexagonal microwave ferrite material; the second sintering treatment comprises: first performing a sintering in air, and then performing a sintering in oxygen at a temperature of 1150-1250° C.; the low line-width W-type hexagonal microwave ferrite material has a line-width of less than 400 Oe.

In the preparation method for the low line-width W-type hexagonal microwave ferrite material of the present application, by replacing partial Fe ions with rare-earth element Gd, and limiting x in the chemical formula of BaGdₓNi₂Fe₍₁₆₋ₓ₎O₂₇ to be less than 0.25 and more than 0.1, the electromagnetic characteristics and compensation points of Gd and Fe are utilized to obtain an appropriate saturation magnetization, remanence ratio, and line-width, and by the combined addition of the low-melting-point fluxing agent including 0.01-0.1% of Bi₂O₃, 0.01-0.1% of V₂O₅, 0.01-0.1% of SiO₂, and 0.01-0.1% of ZnO by mass content, the microstructure of the W-type hexagonal microwave ferrite material can be improved, pores can be reduced, the line width can be reduced, and the remanence ratio can be increased. In the preparation method of the present application, the sintering in oxygen with a temperature of 1150-1250° C. is also adopted to reduce the pores in the W-type hexagonal microwave ferrite material, reduce the line-width of the material effectively, and inhibit the appearance of Fe²⁺, preventing reducing the dielectric loss of the material.

In the preparation method of the present application, the particle size X50 of the slurry after the first ball-milling treatment is limited to 0.9-1.2 μm, and the particle size X50 of the slurry after the second ball-milling treatment is limited to 0.8-1.1 μm, so that most of the particles are in a single domain state, which is conducive to the rotation of the magnetic moment under the action of the oriented magnetic field to obtain a good orientation result, improve the remanence ratio, and also reduce the porosity effectively. Moreover, the first sintering treatment is performed at a temperature of 1200-1280° C., if the temperature is lower than 1200° C., the grain size will not be fully grown, so that the density will be low, and the porosity will be increased, thereby increasing the line-width; if the temperature is higher than 1280° C., the oversize grains will be generated, pores will be increased, and the remanence ratio will be decreased, thereby increasing the line-width.

In the present application, 0.1<x<0.25, which can be, for example, 0.11, 0.13, 0.15, 0.18, 0.2, or 0.24; however, the x is not limited to the listed values, and other unlisted values within the numerical range are also applicable;
the slurry after the first ball-milling treatment has a particle size X50 of 0.9-1.2 μm, which can be, for example, 0.9 μm, 0.95 μm, 1 μm, 1.05 μm, 1.1 μm, or 1.2 μm; however, the particle size X50 is not limited to the listed values, and other unlisted values within the numerical range are also applicable;
the first sintering treatment is performed at a temperature of 1200-1280° C., which can be, for example, 1200° C., 1210° C., 1220° C., 1250° C., 1270° C., or 1280° C.; however, the temperature is not limited to the listed values, and other unlisted values within the numerical range are also applicable;
the slurry after the second ball-milling treatment has a particle size X50 of 0.8-1.1 μm, which can be, for example, 0.8 μm, 0.85 μm, 0.9 μm, 0.95 μm, 1 μm, or 1.1 μm; however, the particle size X50 is not limited to the listed values, and other unlisted values within the numerical range are also applicable;
components and mass contents of the fluxing agent are 0.01-0.1% of Bi₂O₃, 0.01-0.1% of V₂O₅, 0.01-0.1% of SiO₂, and 0.01-0.1% of ZnO, respectively; wherein, the content 0.01-0.1% of Bi₂O₃ can be, for example, 0.01%, 0.02%, 0.04%, 0.05%, 0.08%, or 0.1%, however, the mass content is not limited to the listed values, and other unlisted values within the numerical range are also applicable; the content 0.01-0.1% of V₂O₅ can be, for example, 0.01%, 0.02%, 0.04%, 0.05%, 0.08%, or 0.1%, however, the mass content is not limited to the listed values, and other unlisted values within the numerical range are also applicable; the content 0.01-0.1% of SiO₂ can be, for example, 0.01%, 0.02%, 0.04%, 0.05%, 0.08%, or 0.1%, however, the mass content is not limited to the listed values, and other unlisted values within the numerical range are also applicable; the content 0.01-0.1% of ZnO can be, for example, 0.01%, 0.02%, 0.04%, 0.05%, 0.08%, or 0.1%, however, the mass content is not limited to the listed values, and other unlisted values within the numerical range are also applicable;
the sintering in oxygen is performed at a temperature of 1150-1250° C., which can be, for example, 1150° C., 1155° C., 1180° C., 1200° C., 1220° C., or 1250° C.; however, the temperature is not limited to the listed values, and other unlisted values within the numerical range are also applicable;
the low line-width W-type hexagonal microwave ferrite material has a line-width of less than 400 Oe, which can be, for example, 399 Oe, 390 Oe, 380 Oe, 370 Oe, 350 Oe, or 320 Oe; however, the line-width is not limited to the listed values, and other unlisted values within the numerical range are also applicable.

Preferably, the first ball-milling treatment in step (1) is performed at a rotational speed of 60-80 r/min, which can be, for example, 60 r/min, 62 r/min, 65 r/min, 70 r/min, 75 r/min, or 80 r/min; however, the rotational speed is not limited to the listed values, and other unlisted values within the numerical range are also applicable.

Preferably, the first ball-milling treatment is performed for a period of 20-40 h, which can be, for example, 20 h, 23 h, 25 h, 30 h, 35 h, 38 h, or 40 h; however, the period is not limited to the listed values, and other unlisted values within the numerical range are also applicable.

Preferably, in the first ball-milling treatment, a dispersant with a mass fraction of 0.01-0.05% is added, which can be, for example, 0.01%, 0.02%, 0.03%, 0.04%, or 0.05%; however, the mass fraction is not limited to the listed values, and other unlisted values within the numerical range are also applicable.

In the present application, the type of dispersant is not specifically limited, and any dispersant that is well known to those skilled in the art for the ball-milling treatment can be used.

Preferably, the drying in step (2) is performed at a temperature of 120-150° C., which can be, for example, 120° C., 125° C., 130° C., 140° C., 145° C., or 150° C.; however, the temperature is not limited to the listed values, and other unlisted values within the numerical range are also applicable.

Preferably, the drying is performed for a period of 16-20 h, which can be, for example, 16 h, 16.5 h, 17 h, 18 h, 19 h, or 20 h; however, the period is not limited to the listed values, and other unlisted values within the numerical range are also applicable.

Preferably, the first sintering treatment in step (2) is performed at a heating rate of 1.0-1.5° C./min, which can be, for example, 1.0° C./min, 1.1° C./min, 1.2° C./min, 1.3° C./min, or 1.5° C./min; however, the heating rate is not limited to the listed values, and other unlisted values within the numerical range are also applicable.

Preferably, the second ball-milling treatment in step (3) is performed at a rotational speed of 60-80 r/min, which can be, for example, 60 r/min, 62 r/min, 65 r/min, 70 r/min, 75 r/min, or 80 r/min; however, the rotational speed is not limited to the listed values, and other unlisted values within the numerical range are also applicable.

Preferably, the second ball-milling treatment is performed for a period of 15-24 h, which can be, for example, 15 h, 18 h, 20 h, 21 h, 23 h, or 24 h; however, the period is not limited to the listed values, and other unlisted values within the numerical range are also applicable.

Preferably, in the second ball-milling treatment in step (3), a dispersant with a mass fraction of 0.01-0.05% is added, which can be, for example, 0.01%, 0.02%, 0.03%, 0.04%, or 0.05%; however, the mass fraction is not limited to the listed values, and other unlisted values within the numerical range are also applicable.

Preferably, the slurry before the granulation-molding in step (4) has a solid content of more than or equal to 70%, which can be, for example, 70%, 72%, 75%, 80%, 85%, or 90%; however, the mass fraction is not limited to the listed values, and other unlisted values within the numerical range are also applicable.

Preferably, the sample obtained from the granulation-molding has a density of 3.4-3.6 g/cm³, which can be, for example, 3.4 g/cm³, 3.41 g/cm³, 3.45 g/cm³, 3.5 g/cm³, 3.55 g/cm³, or 3.6 g/cm³; however, the density is not limited to the listed values, and other unlisted values within the numerical range are also applicable.

Preferably, the sintering in air in step (4) comprises: heating from room temperature to 120° C. at a rate of 1.0° C./min, holding the temperature for 2 h, and then heating to 1000° C. at a rate of 2° C./min.

Preferably, the sintering in oxygen in step (4) comprises: introducing oxygen with an oxygen content of more than or equal to 98% by a flow rate of 30-50 L/min, heating to an oxygen-sintering temperature at a rate of 2.5° C./min, holding the temperature for 3-8 h, and then cooling to 700° C. at a rate of 2.5° C./min, stopping the introduction of oxygen and cooling in furnace.

In the sintering in oxygen, the flow rate is 30-50 L/min, which can be, for example, 30 L/min, 35 L/min, 38 L/min, 40 L/min, 45 L/min, or 50 L/min, however, the flow rate is not limited to the listed values, and other unlisted values within the numerical range are also applicable; the oxygen content is more than or equal to 98%, which can be, for example, 98%, 98.2%, 98.5%, 99%, 99.3%, or 99.5%, however, the oxygen content is not limited to the listed values, and other unlisted values within the numerical range are also applicable; the temperature is held for a period of 3-8 h, which can be, for example, 3 h, 4 h, 5 h, 7 h, or 8 h, however, the period is not limited to the listed values, and other unlisted values within the numerical range are also applicable.

As a preferred technical solution of the present application, the preparation method comprises the following steps:
(1) weighing BaCO₃, Gd₂O₃, Ni₂O, and Fe₂O₃ as raw materials according to calculation based on a chemical formula of BaGdₓNi₂Fe₍₁₆₋ₓ₎O₂₇, in which 0.1<x<0.25, then performing a first ball-milling treatment at a rotational speed of 60-80 r/min for 20-40 h to obtain a first ball-milled slurry with a particle size X50 of 0.9-1.2 μm; in the first ball-milling treatment, a dispersant with a mass fraction of 0.01-0.05% is added;
(2) sequentially subjecting the first ball-milled slurry to drying which is performed at a temperature of 120-150° C. for 16-20 h, and a first sintering treatment which is performed at a temperature of 1200-1280° C. with a heating rate of 1.0-1.5° C./min to obtain a mixed powder;
(3) mixing the mixed powder and a fluxing agent, performing a second ball-milling treatment at a rotational speed of 60-80 r/min for 15-24 h to obtain a second ball-milled slurry with a particle size X50 of 0.8-1.1 μm; components and mass contents of the fluxing agent are: 0.01-0.1% of Bi₂O₃, 0.01-0.1% of V₂O₅, 0.01-0.1% of SiO₂, and 0.01-0.1% of ZnO, respectively; in the second ball-milling treatment, a dispersant with a mass fraction of 0.01-0.05% is added; and
(4) sequentially subjecting the second ball-milled slurry to granulation-molding and a second sintering treatment to obtain the low line-width W-type hexagonal microwave ferrite material; the low line-width W-type hexagonal microwave ferrite material has a line-width of less than 400 Oe;
the slurry before the granulation-molding has a solid content of more than or equal to 70%; a sample obtained from the granulation-molding has a density of 3.4-3.6 g/cm³;
the second sintering treatment comprises first performing a sintering in air, and then performing a sintering in oxygen; the sintering in air comprises: heating from room temperature to 120° C. at a rate of 1.0° C./min, holding the temperature for 2 h, and then heating to 1000° C. at a rate of 2° C./min; the sintering in oxygen comprises: introducing oxygen with an oxygen content of more than or equal to 98% by a flow rate of 30-50 L/min, heating to a sintering temperature of 1150-1250° C. at a rate of 2.5° C./min, holding the temperature for 3-8 h, and then cooling to 700° C. at a rate of 2.5° C./min, stopping the introduction of oxygen and cooling in furnace.

Compared with the relative art, the present application has at least the following beneficial effects.

The preparation method for a low line-width W-type hexagonal microwave ferrite material provided by examples in the present application has a stable process and good repeatability, and the obtained W-type hexagonal microwave ferrite material has a line-width of less than 400 Oe, a saturation magnetization of 3700-3900 Gs, a remanence ratio of more than 0.9, and a density of more than 5.0 g/cm³, which has the prospect of large-scale popularization and application.

After detailed description is read and understood, other aspects can be understood.

### DETAILED DESCRIPTION

To better illustrate the present application, examples are listed below in the present application. Those skilled in the art should understand that the examples merely assist in understanding the present application and should not be regarded as a specific limitation to the present application.

The present application is further explained in detail below. However, the following examples are only brief examples of the present application, and do not represent or limit the protection scope of claims in the present application. The protection scope of the present application is defined by the claims.

### Example 1

The example provides a preparation method for a low line-width W-type hexagonal microwave ferrite material, and the preparation method comprises the following steps:
(1′) raw materials BaCO₃, Gd₂O₃, Ni₂O, and Fe₂O₃ were weighted out according to calculation based on a chemical formula of BaGdₓNi₂Fe₍₁₆₋ₓ₎O₂₇, in which x=0.2; wherein a purity of BaCO₃ was 99.65%, a purity of Gd₂O₃ was 99.5%, a purity of Ni₂O was 99.5%, and a purity of Fe₂O₃ was 99.5%;
(2′) the raw materials were put into a ball-mill tank to be mixed by a ball mill according to a weight ratio of the raw materials to deionized water to zirconium oxide balls (large to small) being 1000:1000:(4000:1000), and subjected to a first ball-milling treatment at a rotational speed of 70 r/min for 24 h; in the first ball-milling treatment, a dispersant with a mass fraction of 0.02% was added; a particle size X50 of the slurry after the first ball-milling treatment was 0.9-1.2 μm;
(3′) the slurry after the first ball-milling treatment was put into an oven and dried at a drying temperature of 140° C. for 18 h; and then the dried powder was sieved with a 60-mesh screen and put into an air-sintering furnace for a first sintering treatment for 5 h, and heated to a first sintering temperature of 1250° C. with a rate of 1.5° C./min to obtain a mixed powder;
(4′) the mixed powder was mixed with a fluxing agent and a dispersant having a mass fraction of 0.02%, and then put into a ball-mill tank to be mixed by using a horizontal ball mill according to a weight ratio of materials to deionized water to zirconium oxide balls (large to small) being 1000:1000:(4000:1000), and subjected to a second ball-milling treatment of 70 r/min for 16 h; a particle size X50 of the slurry after the second ball-milling treatment was 0.8-1.1 μm; components and mass contents of the fluxing agent were 0.06% of Bi₂O₃, 0.06% of V₂O₅, 0.06% of SiO₂, and 0.06% of ZnO, respectively;
(5′) excess water in the slurry after the second ball-milling treatment was filtered off with a filter cloth, so that the solid content of the slurry was more than or equal to 70%;
(6′) the processed slurry was subjected to orientation-molding to obtain a sample having a size of Z42*8 and a molding density of 3.4 g/cm³; and
(7′) the sample was subjected to a sintering in air a and then a sintering in oxygen; the sintering in air comprised: the temperature was raised from room temperature to 120° C. at a rate of 1.0° C./min, held for 2 h, and then raised to 1000° C. at a rate of 2° C./min; the sintering in oxygen comprised: oxygen with an oxygen content of 98% was introduced by a flow rate of 40 L/min, the temperature was raised to an sintering temperature of 1180° C. at a rate of 2.5° C./min, held for 6 h, and then reduced to 700° C. at a rate of 2.5° C./min, oxygen was stopped from being introduced and furnace cooling was performed to obtain the low line-width W-type hexagonal microwave ferrite material.

### Example 2

This example provides a preparation method for a low line-width W-type hexagonal microwave ferrite material. The preparation method in this example is the same as in Example 1 except that x=0.18 in step (1′).

### Comparative Example 1

This comparative example provides a preparation method for a low line-width W-type hexagonal microwave ferrite material. The preparation method in this comparative example is the same as in Example 1 except that x=0 in step (1′).

### Comparative Example 2

This comparative example provides a preparation method for a low line-width W-type hexagonal microwave ferrite material. The preparation method in this comparative example is the same as in Example 1 except that x=0.3 in step (1′).

### Comparative Example 3

This comparative example provides a preparation method for a low line-width W-type hexagonal microwave ferrite material. The preparation method in this comparative example is the same as in Example 1 except that in step (3′), the first sintering treatment was performed at a temperature of 1150° C.

### Comparative Example 4

This comparative example provides a preparation method for a low line-width W-type hexagonal microwave ferrite material. The preparation method in this comparative example is the same as in Example 1 except that in step (3′), the first sintering treatment was performed at a temperature of 1300° C.

### Comparative Example 5

This comparative example provides a preparation method for a low line-width W-type hexagonal microwave ferrite material. The preparation method in this comparative example is the same as in Example 1 except that in step (4′), components and mass contents of the fluxing agent were 0.12% of Bi₂O₃, 0.12% of V₂O₅, 0.12% of SiO₂, and 0.06% of ZnO, respectively.

### Comparative Example 6

This comparative example provides a preparation method for a low line-width W-type hexagonal microwave ferrite material. The preparation method in this comparative example is the same as in Example 1 except that in step (4′), the fluxing agent was not added.

### Comparative Example 7

This comparative example provides a preparation method for a low line-width W-type hexagonal microwave ferrite material. The preparation method in this comparative example is the same as in Example 1 except that in step (4′), components and mass contents of the fluxing agent was 0.12% of V₂O₅, 0.12% of SiO₂, and 0.06% of ZnO, respectively.

### Comparative Example 8

This comparative example provides a preparation method for a low line-width W-type hexagonal microwave ferrite material. The preparation method in this comparative example is the same as in Example 1 except that in step (2′), the first ball-milling treatment was performed for a period of h, and the slurry obtained after the first ball-milling treatment had a particle size X50 of m.

### Comparative Example 9

This comparative example provides a preparation method for a low line-width W-type hexagonal microwave ferrite material. The preparation method in this comparative example is the same as in Example 1 except that in step (4′), the second ball-milling treatment was performed for a period of h, and the slurry obtained after the second ball-milling treatment had a particle size X50 of m.

### Comparative Example 10

This comparative example provides a preparation method for a low line-width W-type hexagonal microwave ferrite material. The preparation method in this comparative example is the same as in Example 1 except that in step (7′), the sintering in oxygen was performed at a temperature of 1100° C.

### Comparative Example 11

This comparative example provides a preparation method for a low line-width W-type hexagonal microwave ferrite material. The preparation method in this comparative example is the same as in Example 1 except that in step (7′), the sintering in oxygen was performed at a temperature of 1280° C.

### Comparative Example 12

This comparative example provides a preparation method for a low line-width W-type hexagonal microwave ferrite material. The preparation method in this example is the same as in Example 1 except that in step (7′), the sintering was performed without introducing oxygen, and air cooling was directly performed.

The W-type hexagonal microwave ferrite materials obtained in the above examples and comparative examples were processed into Φ2.5 mm balls, and the saturation magnetizations of the balls were measured;
the W-type hexagonal microwave ferrite materials obtained in the above examples and comparative examples were processed into Z38*6 samples, and the remanence ratios of the samples were measured;
the W-type hexagonal microwave ferrite materials obtained in the above examples and comparative examples were processed into Φ1 mm balls, and the line-widths of the balls were measured;
the densities of the W-type hexagonal crystalline microwave ferrite materials obtained in the above examples and comparative examples were measured by the water displacement method, and the test results are shown in Table 1.

TABLE 1

| | Saturation | [symbol] emanence | [symbol] ine-width | |
|---|---|---|---|---|
| | magnetization | ratio | ΔH | Density |
| | 4πMs (Gs) | Mr/Ms | (Oe) | (g/cm³) |
| Standard | 3800 ± 100 | >0.9 | <400 | >5.0 |
| Example 1 | 3810 | 0.92 | 366 | 5.05 |
| Example 2 | 3832 | 0.92 | 369 | 5.04 |
| Comparative | 3915 | 0.95 | 769 | 4.86 |
| Example 1 | | | | |
| Comparative | 3812 | 0.86 | 699 | 5.04 |
| Example 2 | | | | |
| Comparative | 3722 | 0.91 | 678 | 5.04 |
| Example 3 | | | | |
| Comparative | 3722 | 0.89 | 828 | 4.94 |
| Example 4 | | | | |
| Comparative | 3722 | 0.84 | 918 | 5.04 |
| Example 5 | | | | |
| Comparative | 3622 | 0.86 | 998 | 4.86 |
| Example 6 | | | | |
| Comparative | 3822 | 0.86 | 998 | 4.86 |
| Example 7 | | | | |
| Comparative | 3722 | 0.88 | 698 | 5.04 |
| Example 8 | | | | |
| Comparative | 3622 | 0.82 | 998 | 4.86 |
| Example 9 | | | | |
| Comparative | 3422 | 0.86 | 898 | 4.85 |
| Example 10 | | | | |
| Comparative | 3822 | 0.88 | 798 | 5.06 |
| Example 11 | | | | |
| Comparative | 3422 | 0.9 | 588 | 5.06 |
| Example 12 | | | | |

[symbol]

indicates data missing or illegible when filed

As can be seen from Table 1, the W-type hexagonal microwave ferrite material obtained by the preparation method provided in the present application has a line-width of less than 400 Oe, a saturation magnetization of 3700-3900 Gs, a remanence ratio of more than 0.9, and a density of more than 5.0 g/cm³, which has the prospect of large-scale popularization and application.

In a case where Gd is not added to the raw material, or the proportion of Gd is too much, the line-width of the obtained W-type hexagonal microwave ferrite material will be high; in a case where the temperature of the first sintering treatment is low, although other properties are comparable to those of Example 1, the line width will be higher; in a case where the fluxing agent is not added, or the composition and content of each substance in the fluxing agent are not within the range of the present application, the W-type hexagonal microwave ferrite material will have a high line-width and a small remanence ratio; in a case where the particle size of the slurry after the first ball-milling treatment and the particle size of the slurry after the second ball-milling treatment are larger, the W-type hexagonal microwave ferrite material will have a high line-width, a small remanence ratio, and a low density; in a case where the temperature of the sintering in oxygen is not within the range of the present application, the W-type hexagonal microwave ferrite material will have a high line-width and a small remanence ratio.

In summary, the preparation method for a low line-width W-type hexagonal microwave ferrite material provided in the present application has a stable process and good repeatability, and has a prospect of large-scale popularization and application.

The applicant declares that the above is only specific embodiments of the present application, but the protection scope of the present application is not limited thereto. Those skilled in the art should understand that any changes or replacements, which can be easily thought of by a person skilled in the art within the scope of the technology disclosed in the present application, shall fall within the protection scope and disclosure scope of the present application.

What is claimed is:

1. A preparation method for a low line-width W-type hexagonal microwave ferrite material, comprising the following steps:
(1) weighing BaCO₃, Gd₂O₃, Ni₂O, and Fe₂O₃ as raw materials according to calculation based on a chemical formula of BaGdₓNi₂Fe₍₁₆₋ₓ₎O₂₇, in which 0.1<x<0.25, and then performing a first ball-milling treatment to obtain a first ball-milled slurry with a particle size X50 of 0.9-1.2 μm;
(2) sequentially subjecting the first ball-milled slurry to drying and a first sintering treatment which is performed at a temperature of 1200-1280° C. to obtain a mixed powder;
(3) mixing the mixed powder and a fluxing agent, and performing a second ball-milling treatment to obtain a second ball-milled slurry with a particle size X50 of 0.8-1.1 μm; components and mass contents of the fluxing agent are: 0.01-0.1% of Bi₂O₃, 0.01-0.1% of V₂O₅, 0.01-0.1% of SiO₂, and 0.01-0.1% of ZnO, respectively; and
(4) sequentially subjecting the second ball-milled slurry to granulation-molding and a second sintering treatment to obtain the low line-width W-type hexagonal microwave ferrite material; the second sintering treatment comprises: first performing a sintering in air, and then performing a sintering in oxygen at a temperature of 1150-1250° C.; the low line-width W-type hexagonal microwave ferrite material has a line-width of less than 400 Oe.

2. The preparation method according to claim 1, wherein the first ball-milling treatment in step (1) is performed at a rotational speed of 60-80 r/min.

3. The preparation method according to claim 1, wherein the first ball-milling treatment is performed for a period of 20-40 h.

4. The preparation method according to claim 1, wherein in the first ball-milling treatment, a dispersant with a mass fraction of 0.01-0.05% is added.

5. The preparation method according to claim 1, wherein the drying in step (2) is performed at a temperature of 120-150° C.

6. The preparation method according to claim 1, wherein the first sintering treatment in step (2) is performed at a heating rate of 1.0-1.5° C./min.

7. The preparation method according to claim 1, wherein the second ball-milling treatment in step (3) is performed at a rotational speed of 60-80 r/min.

8. The preparation method according to claim 1, wherein in the second ball-milling treatment in step (3), a dispersant with a mass fraction of 0.01-0.05% is added.

9. The preparation method according to claim 1, wherein the slurry before the granulation-molding in step (4) has a solid content of more than or equal to 70%.

10. The preparation method according to claim 1, wherein the sintering in air in step (4) comprises: heating from room temperature to 120° C. at a rate of 1.0° C./min, holding the temperature for 2 h, and then heating to 1000° C. at a rate of 2° C./min.

11. The preparation method according to claim 1, wherein the sintering in oxygen in step (4) comprises: introducing oxygen with an oxygen content of more than or equal to 98% by a flow rate of 30-50 L/min, heating to an oxygen-sintering temperature at a rate of 2.5° C./min, holding the temperature for 3-8 h, then cooling to 700° C. at a rate of 2.5° C./min, and stopping the introduction of oxygen and cooling in furnace.

12. The preparation method according to claim 1, comprising the following steps:
(1) weighing BaCO₃, Gd₂O₃, Ni₂O, and Fe₂O₃ as raw materials according to calculation based on a chemical formula of BaGdₓNi₂Fe₍₁₆₋ₓ₎O₂₇, in which 0.1<x<0.25, and then performing a first ball-milling treatment at a rotational speed of 60-80 r/min for 20-40 h to obtain a first ball-milled slurry with a particle size X50 of 0.9-1.2 μm; in the first ball-milling treatment, a dispersant with a mass fraction of 0.01-0.05% is added;
(2) sequentially subjecting the first ball-milled slurry to drying which is performed at a temperature of 120-150° C. for 16-20 h, and a first sintering treatment which is performed at a temperature of 1200-1280° C. with a heating rate of 1.0-1.5° C./min to obtain a mixed powder;
(3) mixing the mixed powder and a fluxing agent, and performing a second ball-milling treatment at a rotational speed of 60-80 r/min for 15-24 h to obtain a second ball-milled slurry with a particle size X50 of 0.8-1.1 μm; components and mass contents of the fluxing agent are: 0.01-0.1% of Bi₂O₃, 0.01-0.1% of V₂O₅, 0.01-0.1% of SiO₂, and 0.01-0.1% of ZnO, respectively; in the second ball-milling treatment, a dispersant with a mass fraction of 0.01-0.05% is added; and
(4) sequentially subjecting the second ball-milled slurry to granulation-molding and a second sintering treatment to obtain the low line-width W-type hexagonal microwave ferrite material; the low line-width W-type hexagonal microwave ferrite material has a line-width of less than 400 Oe;
the slurry before the granulation-molding has a solid content of more than or equal to 70%; a sample obtained from the granulation-molding has a density of 3.4-3.6 g/cm³;
the second sintering treatment comprises first performing a sintering in air and then performing a sintering in oxygen; the sintering in air comprises: heating from room temperature to 120° C. at a rate of 1.0° C./min, holding the temperature for 2 h, and then heating to 1000° C. at a rate of 2° C./min; the sintering in oxygen comprises: introducing oxygen with an oxygen content of more than or equal to 98% by a flow rate of 30-50 L/min, heating to a sintering temperature of 1150-1250° C. at a rate of 2.5° C./min, holding the temperature for 3-8 h, then cooling to 700° C. at a rate of 2.5° C./min, and stopping the introduction of oxygen and cooling in furnace.

13. The preparation method according to claim 1, wherein the drying in step (2) is performed for a period of 16-20 h.

14. The preparation method according to claim 1, wherein the second ball-milling treatment in step (3) is performed for a period of 15-24 h.

15. The preparation method according to claim 1, wherein a sample obtained from the granulation-molding has a density of 3.4-3.6 g/cm³.
